(19) United States
(12) Patent Application Publication
(10) Pub. No.: US 2022/0384801 A1
(43) Pub. Date: Dec. 1, 2022

(54) POSITIVE ACTIVE MATERIAL FOR RECHARGEABLE LITHIUM BATTERY, METHOD OF PREPARING THE SAME, AND RECHARGEABLE LITHIUM BATTERY INCLUDING THE SAME

(71) Applicant: SAMSUNG SDI CO., LTD., Yongin-si (KR)

(72) Inventors: Youngsun KONG, Yongin-si (KR); Kiyong AHN, Yongin-si (KR); Seonyoung KWON, Yongin-si (KR); Min Ju KIM, Yongin-si (KR); Dookyun LEE, Yongin-si (KR); Dowook JUN, Yongin-si (KR); Kijoo HONG, Yongin-si (KR)

(21) Appl. No.: 17/655,961

(22) Filed: Mar. 22, 2022

(30) Foreign Application Priority Data
Jun. 1, 2021 (KR) 10-2021-0070990

(51) Int. Cl. H01M 4/525; H01M 4/505; H01M 4/36; H01M 4/04; H01M 10/0525

(52) U.S. Cl. CPC H01M 4/525; H01M 4/505; H01M 4/366; H01M 4/0471; H01M 10/0525; H01M 2004/028

(57) ABSTRACT

A positive active material includes a nickel-based composite metal oxide having the form of secondary particles in which a plurality of primary particles are agglomerated, where each secondary particle includes a core and a shell, the primary particles of the shell are coated with a manganese-containing nickel-based composite metal oxide, and the manganese-containing nickel-based composite metal oxide has a layered structure.

### CROSS-REFERENCE TO RELATED APPLICATION

This application claims priority to and the benefit of Korean Patent Application No. 10-2021-0070990, filed in the Korean Intellectual Property Office on Jun. 1, 2021, the entire content of which is incorporated herein by reference.

### BACKGROUND

### 1. Field

One or more aspects of embodiments of the present disclosure relate to a positive active material for a rechargeable lithium battery, a method of preparing the same, and a rechargeable lithium battery including the same.

### 2. Description of the Related Art

In order to meet down-sizing and high performance specifications of various devices, rechargeable lithium batteries have become increasingly important in terms of achieving high energy density, down-sizing, and/or weight reduction. In addition, high capacity, high temperature stability, and high voltage safety are important features of rechargeable lithium batteries applied to electric vehicles and/or the like.

Various positive active materials have been investigated to realize rechargeable lithium batteries for the above applications.

Nickel-based lithium transition metal oxides simultaneously including Ni, Co, Mn, and/or the like (e.g., NMC-type active materials) provide high discharge capacity per unit weight, compared with LiCoO₂, but have relatively low capacity and discharge capacity per unit volume due to low packing density. In addition, safety of the nickel-based lithium transition metal oxide may be deteriorated, when the battery is driven at a high voltage.

Accordingly, a method for improving structural stability and/or cycle-life of the nickel-based lithium transition metal oxide is desired.

### SUMMARY

One or more aspects of embodiments of the present disclosure are directed toward a positive active material having improved structural stability and improved cycle-life when utilized in a rechargeable lithium battery.

One or more aspects of embodiments of the present disclosure are directed toward a method of preparing the positive active material.

One or more aspects of embodiments of the present disclosure are directed toward a rechargeable lithium battery having improved charge/discharge efficiency and/or cycle-life characteristics by employing a positive electrode including the positive active material.

One or more embodiments of the present disclosure provide a positive active material including a nickel-based composite metal oxide including (e.g., having the form of) secondary particles in which a plurality of primary particles are agglomerated, wherein the positive active material (e.g., the nickel-based composite metal oxide) includes a core and a shell, the primary particles of the shell are coated with a manganese-containing nickel-based composite metal oxide, and the manganese-containing nickel-based composite metal oxide has a layered structure.

The core may not include (e.g., may exclude) manganese.

A manganese concentration in the manganese-containing nickel-based composite metal oxide may have a concentration gradient in which it increases (e.g., may increase along a gradient) from the interior (inside) to the surface of the primary particle of the shell.

The coating of manganese coated on the shell (e.g., on the primary particles of the shell) may be in an island form or in a fine nanoparticle form.

The content (e.g., amount) of manganese in the positive active material may be less than about 1.5 mol %, for example with respect to the manganese-containing nickel-based composite metal oxide of the shell.

A thickness of the shell may be less than or equal to about 2 μm.

The positive active material may have a particle diameter of about 8 μm to about 18 μm.

The manganese-containing nickel-based composite metal oxide may be represented by Chemical Formula 1:

LiNi_{1-x-y-z}CoₓMn_{y}M_{z}O₂. Chemical Formula 1

In Chemical Formula 1,

0≤x≤0.5, 0.001≤y<0.015, 0≤z≤0.3, and M is at least one metal element selected from nickel (Ni), aluminum (Al), chromium (Cr), iron (Fe), vanadium (V), magnesium (Mg), titanium (Ti), zirconium (Zr), niobium (Nb), molybdenum (Mo), tungsten (W), copper (Cu), zinc (Zn), gallium (Ga), indium (In), tin (Sn), lanthanum (La), boron (B), tantalum (Ta), praseodymium (Pr), silicon (Si), barium (Ba), and cerium (Ce).

LiMnO₂ may be included on the surface of the primary particle of the shell.

In an embodiment, the positive active material may be prepared by the following method:

an act of adding a water-soluble solvent to a nickel-based composite metal compound and a manganese hydroxide to prepare a mixture,

an act of reacting the mixture at about 40° C. to about 100° C. for about 30 minutes to about 1 hour to coat the primary particles of the shell with manganese, and

an act of mixing the coated resulting material with the lithium source and firing the same.

The nickel-based composite metal compound may be a nickel composite metal oxide or a nickel composite metal hydroxide.

The water-soluble solvent may include NaOH, KOH, or a mixture thereof.

After reacting the mixture at about 40° C. to about 100° C. for about 30 minutes to about 1 hour, the mixture may be dried at about 100° C. to about 200° C.; for example, the method may further include an act of drying the mixture at about 100° C. to about 200° C. after the act of reacting the mixture.

A firing temperature may be about 600° C. to about 800° C. and a firing time may be about 8 hours to about 30 hours or about 8 hours to about 24 hours.

One or more embodiments of the present disclosure provide a rechargeable lithium battery including a positive electrode including the positive active material, a negative electrode including a negative active material, and an electrolyte.

Other details and embodiments are included in the detailed description.

The positive active material does not include a nickel-based composite metal oxide having a spinel structure, and instead includes only the nickel-based composite metal oxide of the layered structure (e.g., alone), thereby solving the problem of a decrease in specific capacity caused by the inclusion of the spinel structure.

The rechargeable lithium battery including the positive electrode including the positive active material according to an embodiment exhibits improved charge and discharge efficiency and/or cycle-life characteristics.

### BRIEF DESCRIPTION OF THE DRAWINGS

FIG. 1 is a schematic cross-sectional view showing a positive active material according to an embodiment.

FIG. 2 is a perspective view schematically illustrating a typical structure of a rechargeable lithium battery.

FIG. 3 shows the evaluation results of cycle-life (100 cycles) of the coin cells of Example 1 and Comparative Examples 1 to 4.

### DETAILED DESCRIPTION

Hereinafter, embodiments are described in more detail. However, the embodiments are provided as examples, the present disclosure is not limited thereto, and the present disclosure is only defined by the scope of the claims to be described later.

It will be understood that when an element such as a layer, film, region, or substrate is referred to as being “on” another element, it can be directly on the other element or intervening elements may also be present. When an element is referred to as being “directly on,” another element, there are no intervening elements present.

As used herein, singular forms such as “a,” “an,” and “the” are intended to include the plural forms as well, unless the context clearly indicates otherwise. It will be further understood that the terms “includes,” “including,” “comprises,” and/or “comprising,” when used in this specification, specify the presence of stated features, steps, operations, elements, and/or components, but do not preclude the presence or addition of one or more other features, steps, operations, elements, components, and/or groups thereof.

As used herein, the terms “use,” “using,” and “used” may be considered synonymous with the terms “utilize,” “utilizing,” and “utilized,” respectively. As used herein, the term “and/or” includes any and all combinations of one or more of the associated listed items. As used herein, expressions such as “at least one of,” “one of,” and “selected from,” when preceding a list of elements, modify the entire list of elements and do not modify the individual elements of the list.

The term “may” will be understood to refer to “one or more embodiments,” some of which include the described element and some of which exclude that element and/or include an alternate element. Similarly, alternative language such as “or” refers to “one or more embodiments,” each including a corresponding listed item.

In the present disclosure, the “particle size” or “particle diameter” may be defined as the average particle diameter (D50) at about 50% cumulative volume in a particle size-distribution curve. The particle diameter may be, for example, measured by electron microscopy (such as scanning electron microscopy (SEM) and/or a field emission scanning electron microscopy (FE-SEM)), or by a laser diffraction method. It may be measured by the laser diffraction method as follows. The particles to be measured are dispersed in a dispersion medium and then introduced into a commercially available laser diffraction particle size measuring apparatus (for example, MT 3000 by Microtrac), and irradiated with ultrasonic waves of about 28 kHz with an output of about 60 W, and an average particle diameter (D50) in 50% reference of the particle size distribution in a measuring apparatus may be calculated from the output data.

In the present specification, the term “center” refers to a point that bisects the longest axis of a particle (e.g., the midpoint of the longest axis of a particle).

The term “primary particle” may refer to a crystalline particle or a grain. A plurality of the primary particles may be agglomerated together to form a secondary particle, wherein the primary particles may have various suitable shapes (such as a spherical shape, a similar spherical shape, a flake shape, and/or the like) and may form grain boundaries therebetween.

The term “secondary particle” refers to a particle that includes a plurality of the primary particles but is not an agglomerate of other particles (e.g., is not itself part of a bigger agglomerate) or a particle that is no longer agglomerated, and may have a spherical shape or a pseudo spherical shape.

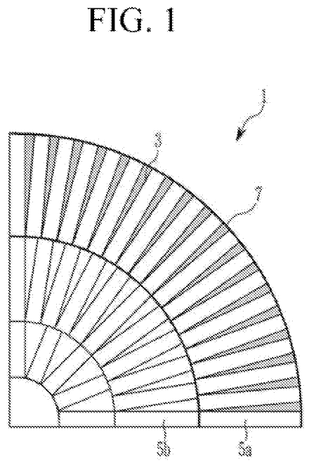

Hereinafter, a positive active material for a rechargeable lithium battery is described with reference to FIG. 1. FIG. 1 is a schematic cross-sectional view showing a quadrant of a positive active material including primary particles coated at a grain boundary according to an embodiment.

Referring to FIG. 1, a positive active material according to an embodiment includes a nickel-based composite metal oxide including secondary particles 1 in which a plurality of primary particles 3 are agglomerated.

The secondary particle 1 includes a core 5b and a shell 5a, and the shell 5a includes a nickel-based composite metal oxide including manganese coated on (e.g., in or along) a grain boundary 7 between (e.g., among) of a plurality of primary particles 3 (hereinafter, also referred to as a manganese-containing nickel-based composite metal oxide). For example, the positive active material may include a manganese-containing nickel-based composite metal oxide coated at a grain boundary between the primary particles 3 of the shell 5a up to a set or predetermined depth. For example, the core 5b of the secondary particle 1 may not include (e.g., may exclude) the manganese-containing nickel-based composite metal oxide. For example, the manganese-containing nickel-based composite metal oxide may be coated only on the grain boundaries of the primary particles 3 in the shell 5a of the secondary particles 1, and manganese (e.g., the manganese-containing nickel-based composite metal oxide) may not be coated in the core 5b.

The core 5b of the secondary particle 1 may refer to a region of less than or equal to about 50 length % to less than or equal to about 80 length % from the center (e.g., a central portion including a percentage of the particle radius), for example, of less than or equal to about 75 length % from the center, less than or equal to about 70 length %, less than or equal to about 65 length %, less than or equal to about 60 length %, less than or equal to about 55 length %, or less than or equal to about 50 length % with respect to a total distance (100 length %) from the center to the outermost surface of the secondary particle 1 or a region excluding the region within about 2 μm from the outermost surface of the secondary particle 1.

The shell 5a is a portion excluding the core 5b, and may refer to a region of less than or equal to about 20 length % from the outermost surface to less than or equal to about 50 length % (e.g., an outer portion including a percentage of the particle radius), for example less than or equal to about 25 length %, less than or equal to about 30 length %, less than or equal to about 20 length %, less than or equal to about 40 length %, less than or equal to about 45 length %, or less than or equal to about 50 length % from the outermost surface with respect to the total distance (100 length %) from the outermost surface to the center.

For example, the thickness of the shell 5a may be less than or equal to about 2 μm, and specifically, the thickness of the shell 5a may be less than or equal to about 2 μm, less than or equal to about 1.5 μm, less than or equal to about 1.0 μm, or less than or equal to about 0.5 μm.

The shell 5a may be a region in which the primary particles 3 are coated at the grain boundaries. In an embodiment, the size (e.g., average diameter) of the primary particles 3 may be about 50 nm to 800 nm or about 100 nm to about 800 nm. The size of the primary particles 3 may be greater than or equal to about 50 nm, greater than or equal to about 100 nm, greater than or equal to about 150 nm, greater than or equal to about 200 nm, greater than or equal to about 250 nm, greater than or equal to about 300 nm, greater than or equal to about 350 nm, greater than or equal to about 400 nm, greater than or equal to about 450 nm, greater than or equal to about 500 nm, greater than or equal to about 550 nm, greater than or equal to about 600 nm, greater than or equal to about 650 nm, greater than or equal to about 700 nm, or greater than or equal to about 750 nm. In another embodiment, the size of the primary particle 3 may be less than or equal to about 800 nm, less than or equal to about 750 nm, less than or equal to about 700 nm, less than or equal to about 650 nm, less than or equal to about 600 nm, less than or equal to about 550 nm, less than or equal to about 500 nm, less than or equal to about 450 nm, less than or equal to about 400 nm, less than or equal to about 350 nm, less than or equal to about 300 nm, less than or equal to about 250 nm, less than or equal to about 200 nm, or less than or equal to about 150 nm.

The manganese-containing nickel-based composite metal oxide may have a layered structure (e.g., layered crystal structure). When the nickel-based composite metal oxide of the positive active material has a spinel structure, stability may be increased, but because the nickel-based composite metal oxide of the spinel structure occupies a larger capacity (e.g., volume and/or weight) in the positive active material than the nickel-based composite metal oxide of the layered structure (e.g., due to having a lower energy density), as the amount of nickel-based metal composite oxide of the spinel structure is increased, the positive active material may have deteriorated specific capacity.

Accordingly, the present disclosure provides a positive active material for a rechargeable lithium battery having excellent or suitable stability and/or high specific capacity by including the nickel-based composite metal oxide of the layered structure instead of the nickel-based composite metal oxide of the spinel structure, and the nickel-based composite metal oxide of the layered structure may be included between the primary particles included in the shell of the positive active material with a core-shell structure.

In other words, in the secondary particle 1, only the manganese-containing nickel-based composite metal oxide of the layered structure may be included, and a compound with a spinel structure or a compound with a rock salt structure may not be included at all (e.g., may be substantially excluded). When the compound with the spinel structure is not included in the secondary particle 1, the problem of specific capacity deterioration due to the spinel structure included in the positive active material may be solved.

The shell 5a includes the manganese-containing nickel-based composite metal oxide of the layered structure between the primary particles 3 (i.e., on or along grain boundaries), and manganese present in the grain boundaries 7 of a plurality of the primary particles 3 in the shell 5a may be included in a larger content (e.g., amount) than manganese coated inside the primary particles 3. In other words, the manganese-containing nickel-based composite metal oxide included in the shell 5a may have a manganese concentration gradient increasing from the interior (inside) of the primary particle 3 to the surface.

The term “grain boundary” refers to an interface of (e.g., between) two adjacent primary particles 3. In an embodiment, the grain boundary may include a region of less than or equal to about 20 length % to less than or equal to about 40 length % extending from the outermost surface of a primary particle (e.g., along the interface between the adjacent primary particles 3) toward the inside of the particle, based on the total distance from a center of the primary particle 3 to the outermost surface, for example, a region of less than or equal to about 25 length % from the outermost surface, a region of less than or equal to about 30 length % from the outermost surface, or a region of less than or equal to about 35 length % from the outermost surface. The “inside” of the primary particle 3 refers to a portion of the particle excluding the grain boundary region. In an embodiment, the interior or inside of the primary particle 3 may refer to a region of less than or equal to about 60 length % from the center of the primary particle 3 to less than or equal to about 80 length % from the center of the primary particle 3, based on the total distance from the center of the primary particle to the outermost surface (the interface between adjacent primary particles 3), for example, less than or equal to about 40 length % from the center of the primary particle, less than or equal to about 45 length % from the center of the primary particle, less than or equal to about 50 length % from the center of the primary particle, less than or equal to about 55 length % from the center of the primary particle, less than or equal to about 60 length % from the center of the primary particle, less than or equal to about 65 length % from the center of the primary particle, less than or equal to about 70 length % from the center of the primary particle, less than or equal to about 75 length % from the center of the primary particle, or less than or equal to about 80 length % from the center of the primary particle.

The manganese-containing nickel-based composite metal oxide coated on the primary particle 3 of the shell 5a may be coated in an island form or a fine nanoparticle form. The ‘fine nanoparticle’ may be or include spherical, rod, needle, and/or plate-shaped particles with a particle size of about 10 nm to about 100 nm.

In an embodiment, the manganese-containing nickel-based composite metal oxide may include manganese in an amount of greater than or equal to about 0.1 mol % and less than about 1.5 mol % based on the total amount (mol %) of the metals (hereinafter, metals except lithium) of the nickel-based composite metal oxide. When the positive active material includes manganese in an amount of greater than or equal to about 0.1 mol % and less than about 1.5 mol % based on the total amount (mol %) of the metals of the nickel-based composite metal oxide, structural stability and/or cycle characteristics of the positive active material may be improved.

In an embodiment, the manganese content (e.g., amount) may be greater than or equal to about 0.1 mol %, greater than or equal to about 0.2 mol %, greater than or equal to about 0.3 mol %, greater than or equal to about 0.4 mol %, greater than or equal to about 0.5 mol %, greater than or equal to about 0.6 mol %, greater than or equal to about 0.7 mol %, greater than or equal to about 0.8 mol %, greater than or equal to about 0.9 mol %, greater than or equal to about 1.0 mol %, greater than or equal to about 1.1 mol %, greater than or equal to about 1.2 mol %, greater than or equal to about 1.3 mol %, or greater than or equal to about 1.4 mol %, and less than about 1.5 mol %, less than or equal to about 1.4 mol %, less than or equal to about 1.3 mol %, less than or equal to about 1.2 mol %, less than or equal to about 1.1 mol %, less than or equal to about 1.0 mol %, less than or equal to about 0.9 mol %, less than or equal to about 0.8 mol %, less than or equal to about 0.7 mol %, less than or equal to about 0.6 mol %, less than or equal to about 0.5 mol %, less than or equal to about 0.4 mol %, less than or equal to about 0.3 mol %, or less than or equal to about 0.2 mol % based on the total amount (mol %) of the metals (metals except lithium) of the manganese-containing nickel-based composite metal oxide.

As described above, the positive active material according to embodiments includes a nickel-based composite metal oxide that includes manganese in a high concentration between the primary particles present in the shell 5a up to a certain depth from the outermost surface of the secondary particles 1. This positive active material embodiment may be different from a related art configuration that includes coating the surface of a secondary particle or doping deep down to a core of the secondary particle, and may have relatively improved specific capacity of the due to manganese being coated only on the grain boundary of the primary particle down to a set or predetermined depth from the outermost surface.

Because the manganese-containing nickel-based composite metal oxide 7 (nickel-based lithium metal oxide) is included (e.g. present) in the grain boundary (boundaries) of the primary particle 3, lithium may be smoothly diffused from a core 5b of the secondary particle 5 (e.g., smoothly diffused between the core 5b and the surrounding electrolyte), but elution of nickel ions from the core 5b of the secondary particle 5 may be suppressed or reduced. In addition, side reactions between the primary particles of the core 5b of the secondary particle 5 and the electrolyte solution may be suppressed or reduced. Accordingly, cycle characteristics of a rechargeable lithium battery including the positive active material with the above structure may be improved.

In some embodiments, the manganese-containing nickel-based composite metal oxide 7 disposed on the grain boundary (boundaries) of the adjacent primary particles 3 may accommodate volume changes of the primary particles during charging and discharging and suppress or reduce cracks between the primary particles that would deteriorate mechanical strength of the positive active material after long-term cycling, thereby preventing or reducing degradation of a rechargeable lithium battery. In addition, the manganese coated on the primary particle 3 stabilizes a crystal structure of the nickel-based metal composite oxide, providing much improved cycle characteristics of a rechargeable lithium battery including the positive active material.

The manganese-containing nickel-based composite metal oxide may be represented by Chemical Formula 1:

LiNi_{1-x-y-z}CoₓMn_{y}M_{z}O₂ Chemical Formula 1

In Chemical Formula 1,

0≤x≤0.5, 0.001≤y<0.015, 0≤z≤0.3, and M is at least one metal or metalloid element selected from nickel (Ni), aluminum (Al), chromium (Cr), iron (Fe), vanadium (V), magnesium (Mg), titanium (Ti), zirconium (Zr), niobium (Nb), molybdenum (Mo), tungsten (W), copper (Cu), zinc (Zn), gallium (Ga), indium (In), tin (Sn), lanthanum (La), boron (B), tantalum (Ta), praseodymium (Pr), silicon (Si), barium (Ba), and cerium (Ce).

In an embodiment, the compound of Chemical Formula 1 may be LiNi_{1-x-y}CoₓMN_{y}O₂, or LiNi_{1-x-y-z}CoₓMn_{y}Al_{z}O₂.

Because the manganese-containing nickel-based composite metal oxide contains nickel in a relatively high content (e.g., amount), capacity may be maximized or increased. When the nickel is included in a high content (e.g., amount), there may be a problem of a low cycle-life despite high capacity, but when manganese is included in a set or predetermined content (e.g., amount), the problem of the low cycle-life may be solved.

In an embodiment, y of Chemical Formula 1 may be in the range of 0.001≤y <0.015. In an embodiment, the manganese-containing nickel-based composite metal oxide 7 may be Li[(NiCoAl)_{0.995}Mn_{0.005}]O₂, Li[(NiCoAl)_{0.99}Mn_{0.01}]O₂, Li[(NiCoAl)_{0.986}Mn_{0.014}]O₂, or a combination thereof (wherein, in these formulae, the molar amounts of Ni, Co, and Al are not necessarily equal, but are described in shorthand to focus on the amount of manganese).

In an embodiment, lithium manganese oxide may be further included in the grain boundary 7 of the primary particles 3 of the shell 5a, and the lithium manganese oxide may be LiMnO₂.

A particle diameter (D50) of the positive active material (e.g., a particle diameter (D50) of the secondary particles of the positive active material) may be about 8 μm to about 18 μm. For example, the particle diameter of the positive active material may be greater than or equal to about 8 μm, greater than or equal to about 9 μm, greater than or equal to about 10 μm, greater than or equal to about 11 μm, greater than or equal to about 12 μm, greater than or equal to about 13 μm, greater than or equal to about 14 μm, greater than or equal to about 15 μm, greater than or equal to about 16 μm, or greater than or equal to about 17 μm, and less than or equal to about 18 μm, less than or equal to about 17 μm, less than or equal to about 16 μm, less than or equal to about 15 μm, less than or equal to about 14 μm, less than or equal to about 13 μm, less than or equal to about 12 μm, less than or equal to about 11 μm, less than or equal to about 10 μm, or less than or equal to about 9 μm.

The positive active material may be prepared according to the following preparation method.

First, a manganese compound is mixed with a nickel-based composite metal compound including secondary particles in which a plurality of primary particles are agglomerated.

The nickel-based composite metal compound may be a nickel composite metal oxide or a nickel composite metal hydroxide, and in an embodiment, the nickel-based composite metal compound may be a compound represented by Chemical Formula 2 or Chemical Formula 3:

Ni_{1-x-y}CoₓM_{y}(OH)₂ Chemical Formula 2

In Chemical Formula 2,

0≤x≤0.5, 0≤y≤0.3, and M is at least one metal or metalloid element selected from Ni, Al, Cr, Fe, V, Mg, Ti, Zr, Nb, Mo, W, Cu, Zn, Ga, In, Sn, La, B, Ta, Pr, Si, Ba, and Ce,

Ni_{1-x-y}CoₓM_{y}O₂ Chemical Formula 3

In Chemical Formula 3,

0≤x≤0.5, 0≤y≤0.3, and M is at least one metal or metalloid element selected from Ni, Al, Cr, Fe, V, Mg, Ti, Zr, Nb, Mo, W, Cu, Zn, Ga, In, Sn, La, B, Ta, Pr, Si, Ba, and Ce.

The compound represented by Chemical Formula 2 may be Ni₁₋ₓCoₓ(OH)₂, or Ni_{1-x-y}CoₓAl_{y}(OH)₂, and the compound represented by Chemical Formula 3 may be Ni₁₋ₓCoₓO₂, or Ni_{1-x-y}CoₓAl_{y}O₂.

The manganese compound may be manganese hydroxide (Mn(OH)₂).

When mixing the nickel-based composite metal compound and the manganese compound, a water-soluble solvent may be added and mixed by a wet mixing method. This is because there is a high probability that the manganese compound will be present (e.g., will remain) on the surface of the shell rather than within the grain boundary of the primary particles of the shell of the nickel-based composite metal compound when dry mixing is utilized.

The water-soluble solvent may include any one of NaOH, KOH, and/or mixtures thereof.

After mixing the nickel-based composite metal compound and the manganese compound, the mixture is reacted in a coating reactor to uniformly distribute manganese at the grain boundaries of the primary particles of the shell of the nickel-based composite metal compound, that is, to coat the primary particles of the shell with manganese.

The temperature of the coating reactor may range from about 40° C. to about 100° C., for example, greater than or equal to about 40° C., greater than or equal to about 50° C., greater than or equal to about 60° C., greater than or equal to about 70° C., greater than or equal to about 80° C., or greater than or equal to about 90° C., and less than or equal to about 100° C., less than or equal to about 90° C., less than or equal to about 80° C., less than or equal to about 70° C., less than or equal to about 60° C., or less than or equal to about 50° C. In an embodiment, the reactor temperature may be maintained substantially uniformly during the reaction.

The reaction time may be about 30 minutes to about 1 hour.

The method may further include drying the reacted mixture, to produce a nickel-based composite metal compound having a core-shell structure in which a manganese-containing nickel-based composite metal compound shell is formed on a nickel-based composite metal compound core.

The drying temperature may be about 100° C. to about 200° C., about 120° C. to about 180° C., or about 140° C. to about 160° C.

Thereafter, a lithium source is mixed with the coated resultant and fired to obtain a positive active material that is a nickel-based composite metal oxide. The lithium source may be LiOH, Li₂CO₃, or a hydrate thereof.

The firing temperature may range from about 600° C. to about 800° C., or for example greater than or equal to about 600° C., greater than or equal to about 620° C., greater than or equal to about 640° C., greater than or equal to about 660° C., greater than or equal to about 680° C., greater than or equal to about 700° C., greater than or equal to about 720° C., greater than or equal to about 740° C., greater than or equal to about 760° C., or greater than or equal to about 780° C., and less than or equal to about and 800° C., less than or equal to about 780° C., less than or equal to about 760° C., less than or equal to about 740° C., less than or equal to about 720° C., less than or equal to about 700° C., less than or equal to about 680° C., less than or equal to about 660° C., less than or equal to about 640° C., or less than or equal to about 620° C.

The firing time may be about 8 hours to about 30 hours, about 8 hours to about 24 hours, or about 10 hours to about 24 hours.

Herein, the nickel-based composite metal compound may be fired at a temperature of about 500° C. to about 800° C. in addition to the firing process.

In another embodiment, a rechargeable lithium battery includes a positive electrode including the positive active material, a negative electrode including a negative active material; and an electrolyte.

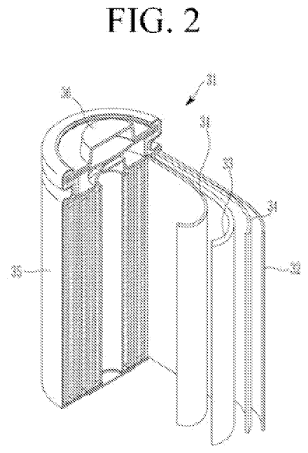

Hereinafter, a rechargeable lithium battery according to an embodiment is described with reference to the drawings. FIG. 2 is a perspective view schematically illustrating a typical structure of a rechargeable lithium battery according to an embodiment.

Referring to FIG. 2, the rechargeable lithium battery 31 includes a positive electrode 33 including the positive active material according to an embodiment, a negative electrode 32, and a separator 34. The aforementioned positive electrode 33 including the positive active material, negative electrode 32, and separator 34 are wound or folded and accommodated in the battery case 35. Then, the organic electrolyte is injected into the battery case 35 and sealed utilizing the cap assembly 36 to complete the rechargeable lithium battery 31. The battery case 35 may have a cylindrical shape, a square shape, a thin film shape, and/or the like.

The rechargeable lithium battery may be a lithium ion battery.

The positive electrode and the negative electrode may each be manufactured by applying a composition for forming a positive active material layer and a composition for forming a negative active material layer on respective current collectors, and drying the same.

The composition for forming the positive active material may be prepared by mixing a positive active material, a conductive agent, a binder, and a solvent, and the positive active material may be the same as described above.

The binder may help binding between the active materials, conductive agent, and/or the like as well as binding these materials on a current collector, and non-limiting examples of the binder may be or include polyvinylidene fluoride, polyvinyl alcohol, carboxymethyl cellulose (CMC), starch, hydroxypropyl cellulose, recycled cellulose, polyvinylpyrrolidone, polytetrafluoroethylene, polyethylene, polypropylene, an ethylene-propylene-diene terpolymer (EPDM), sulfonated EPDM, a styrene butadiene rubber, a fluorine rubber, one or more suitable copolymers, and/or the like. The binder may be included in an amount of about 1 part by weight to 5 parts by weight based on the total weight, 100 parts by weight of the positive active material. When the amount of the binder is within this range, the binding force of the active material layer to the current collector may be suitable or good.

The conductive agent is not particularly limited as long as it does not cause an unwanted chemical change in the battery, and has conductivity (e.g., is a conductor). Non-limiting examples of the conductive agent may be or include graphite (such as natural graphite and/or artificial graphite); a carbon-based material (such as carbon black, acetylene black, Ketjen black, channel black, furnace black, lamp black, summer black, and/or the like); a conductive fiber (such as a carbon fiber and/or a metal fiber, and/or the like); carbon fluoride; a metal powder (such as an aluminum and/or nickel powder); zinc oxide, a conductive whisker (such as potassium titanate, and/or the like);

a conductive metal oxide (such as a titanium oxide); and a conductive material (such as a polyphenylene derivative, and/or the like). The amount of the conductive agent may be about 1 part by weight to about 5 parts by weight based on the total weight of 100 parts by weight of the positive active material. When the amount of the conductive agent is within this range, the conductivity characteristics of the resultant electrode may be improved.

Non-limiting examples of the solvent may be or include N-methyl pyrrolidone, and/or the like. The amount of the solvent may be about 1 part by weight to about 10 parts by weight based on the total weight of 100 parts by weight of the positive active material. When the amount of the solvent is within this range, the active material layer may be easily formed.

The positive current collector may have a thickness of about 3 μm to about 500 μm. The material for the positive current collector is not particularly limited as long as it does not cause an unwanted chemical change in the battery and has high conductivity, and may be or include for example, stainless steel, aluminum, nickel, titanium, heat-treated carbon, and/or aluminum or stainless steel that is surface treated with carbon, nickel, titanium, and/or silver. The current collector may have fine irregularities on its surface to increase adhesion to the positive active material, and may be provided in any suitable form (such as a film, a sheet, a foil, a net, a porous body, foam, and/or a non-woven fabric body).

Separately, a negative active material, a binder, a conductive agent, CMC (carboxymethyl cellulose), and a solvent may be mixed to prepare a composition for forming a negative active material layer. The negative active material may be or include a material capable of intercalating and deintercalating lithium ions. Non-limiting examples of the negative active material may be or include a carbon-based material (such as graphite and/or carbon), a lithium metal, an alloy thereof, a silicon oxide-based material, and/or the like. In some embodiments, silicon oxide may be utilized.

The binder and solvent may be substantially the same as available for the positive electrode. The CMC may be utilized as a thickener to assist adhesion and/or to control viscosity during coating. The binder may be added in an amount of about 1 part by weight to about 5 parts by weight based on a total weight of 100 parts by weight of the negative active material. The CMC may be utilized in an amount of about 1 part by weight to about 5 parts by weight based on a total weight of 100 parts by weight of the negative active material. When the amount of CMC is within the above range, adhesion and coating properties may be improved. The solvent may be utilized in an amount of about 10 parts by weight to about 200 parts by weight based on a total weight of 100 parts by weight of the negative active material. When the amount of the solvent is within this range, the negative active material layer may be easily formed.

The negative current collector may have a thickness of about 3 μm to about 500 μm. The material for the negative current collector is not particularly limited as long as it does not cause a chemical change in the battery and has high conductivity. Non-limiting examples may be or include copper; stainless steel; aluminum; nickel; titanium; heat-treated carbon; copper and/or stainless steel surface-treated with carbon, nickel, titanium, and/or silver; an aluminum-cadmium alloy; and/or the like. The negative current collector may have fine irregularities on the surface to increase adhesion to the negative active materials, and may be provided in any suitable form (such as a film, a sheet, a foil, a net, a porous body, foam, and/or a non-woven fabric body), similar to the positive current collector.

A separator may be disposed between the positive electrode and the negative electrode and wound or laminated to form an electrode assembly. The separator may have a pore diameter of about 0.01 μm to about 10 μm, and a thickness of about 5 μm to about 300 μm. Non-limiting examples thereof may be or include an olefin-based polymer (such as polypropylene, polyethylene, and/or the like); and/or a sheet or a nonwoven fabric formed of a glass fiber. When a solid electrolyte such as a polymer is utilized as the electrolyte, the solid electrolyte may also serve as the separator.

When the electrode assembly is accommodated in a case, an electrolyte is injected, and the resultant obtained is sealed, a rechargeable lithium battery is completed. The electrolyte may be a non-aqueous electrolyte including a non-aqueous solvent and a lithium salt, an organic solid electrolyte, an inorganic solid electrolyte, and/or the like. The non-aqueous electrolyte may be or include, for example, an aprotic organic solvent, for example, N-methyl-2-pyrrolidinone, propylene carbonate, ethylene carbonate, butylene carbonate, dimethyl carbonate, diethyl carbonate, gamma-butyrolactone, 1,2-dimethoxyethane, 2-methyl tetrahydrofuran, dimethylsulfoxide, 1,3-dioxolane, formamide, N,N-dimethyl formamide, dioxolane, acetonitrile, nitromethane, methyl formate, methyl acetate, phosphoric acid triester, trimethoxy methane, dioxolane derivative, sulfolane, methyl sulfolane, 1,3-dimethyl-2-imidazolidinone, a propylene carbonate derivative, a tetrahydrofuran derivative, ether, methyl propionate, ethyl propionate, and/or the like. The lithium salt may be a material that is readily soluble in the non-aqueous solvent, and non-limiting examples thereof may be selected from LiPF₆, LiBF₄, LiSbF₆, LiAsF₆, LiN(SO₂C₂F₅)₂, Li(CF₃SO₂)₂N, LiN(SO₃C₂F₅)₂, Li(FSO₂)₂N (lithium bis(fluorosulfonyl)imide), LiFSI), LiC₄F₉SO₃, LiClO₄, LiAlO₂, LiAlCl₄, LiPO₂F₂, LiN(CₓF₂ₓ₊₁SO₂)(C_{y}F_{2y+1}SO₂), where x and y are natural numbers, for example an integer in a range of 1 to 20, lithium difluoro(bisoxolato) phosphate, LiCl, LiI, LiB(C₂O₄)₂ (lithium bis(oxalato) borate, LiBOB), and/or lithium difluoro(oxalato)borate (LiDFOB).

Non-limiting examples of the organic solid electrolyte may be or include a polyethylene derivative, a polyethylene oxide derivative, a polypropylene oxide derivative, a phosphoric acid ester polymer, polyester sulfide, polyvinyl alcohol, polyvinylidene fluoride, and/or the like

Non-limiting examples of the inorganic solid electrolyte may be or include Li₃N, LiI, Li₅NI₂, Li₃N—LiI—LiOH, Li₂SiS₃, Li₄SiO₄, Li₄SiO₄—LiI—LiOH, Li₃PO₄—Li₂S—SiS₂, and/or the like.

Also, the rechargeable lithium battery can be combined with a circuit to form a battery pack, and a single or multiple pack may be utilized for devices requiring high capacity and/or high power as suitable. For example, it may be utilized for a laptop, a smart phone, electric vehicle and/or the like. In some embodiments, the rechargeable lithium battery has excellent or suitable storage stability, cycle-life characteristics, and/or high-rate characteristics at high temperatures, and thus may be utilized in an electric vehicle (EV). For example, it may be utilized for a hybrid vehicle (such as a plug-in hybrid electric vehicle (PHEV)).

The present disclosure is explained in more detail in the following Examples and Comparative Examples. It is to be understood, however, that the Examples are for the purpose of illustration and are not to be construed as limiting the present disclosure.

### EXAMPLE 1

### Preparation of Positive Active Material

In a reactor into which nickel-based composite metal hydroxide (Ni_{0.94}Co_{0.04}Al_{0.02}(OH)₂) and distilled water were put, after supplying N₂ gas at 4000 sccm, an aqueous solution in the reactor was stirred at 300 rpm to 600 rpm and maintained at 45° C. Subsequently, manganese hydroxide at a concentration of 2 M and a 5.5 M NaOH aqueous solution were continuously added to the reactor for 30 minutes to 1 hour. While the temperature in the reactor was maintained at 50° C. to 80° C., the mixture was stirred for 30 minutes to coat 1 mol % of manganese on the nickel-based composite metal hydroxide. Subsequently, the coated product was dried in a vacuum dryer at 150° C., thereby providing a nickel-based composite metal hydroxide with a core-shell structure, having a nickel-based composite metal hydroxide core and a manganese-containing nickel-based composite metal hydroxide shell thereon. Herein, the manganese was included in an amount of 1 mol % based on the total amount of the metals excluding lithium in the shell.

Subsequently, lithium hydroxide and the nickel-based composite metal hydroxide with a core-shell structure were mixed in a mole ratio of 1:1, and then fired at 720° C. for 12 hours, thereby providing a positive active material powder including a Li[Ni_{0.94}Co_{0.04}Al_{0.02}]O₂ core and a Li[Ni_{0.93}Co_{0.04}Al_{0.02}Mn_{0.01}]O₂ shell.

### Manufacture of Positive Electrode

94 wt % of the positive active material, 3 wt % of ketjen black, and 3 wt % of polyvinylidene fluoride were mixed in an N-methyl pyrrolidone solvent to prepare a positive active material slurry. The positive active material slurry was coated on an Al film and then dried and compressed, thereby manufacturing a positive electrode.

### Manufacture of Coin Cell

The manufactured positive electrode, a lithium metal as a counter electrode, a PTFE separator, and a solution in which 1.15 M LiPF₆ was dissolved in a mixed solvent of EC (ethylene carbonate), DEC (diethyl carbonate), and EMC (ethylmethyl carbonate) (in a volume ratio of 3:4:3) as an electrolyte were utilized to manufacture a coin cell.

### EXAMPLE 2

### Preparation of Positive Active Material

In a reactor into which a nickel-based composite metal oxide (Ni_{0.94}Co_{0.04}Al_{0.02}O₂) and distilled water were added, after supplying N₂ gas at 4000 sccm, an aqueous solution in the reactor was stirred at 300 rpm to 600 rpm and maintained at 45° C. Subsequently, manganese hydroxide at a concentration of 2 M and a 5.5 M NaOH aqueous solution were continuously added to the reactor for 30 minutes to 1 hour. While the reactor was maintained at 50° C. to 70° C., the obtained mixture was stirred for 30 minutes to coat 1 mol % of manganese on the nickel-based composite metal oxide. Subsequently, the coated product was dried at 150° C. in a vacuum dryer, thereby providing a nickel-based composite metal oxide with a core-shell structure having a nickel-based composite metal oxide core and a manganese-containing nickel-based composite metal oxide shell formed thereon. Herein, the manganese was included in an amount of 1 mol % based on the total amount of the metals excluding lithium in the shell.

Subsequently, the nickel-based composite metal oxide with a core-shell structure and lithium hydroxide were mixed in a mole ratio of 1:1 and fired at 720° C. for 12 hours, thereby obtaining a positive active material powder including a Li[Ni_{0.94}Co_{0.04}Al_{0.02}]O₂ core and a Li[Ni_{0.93}Co_{0.04}Al_{0.02}Mn_{0.01}]O₂ shell.

### Manufacture of Positive Electrode

94 wt % of the positive active material, 3 wt % of ketjen black, and 3 wt % of polyvinylidene fluoride were mixed in an N-methyl pyrrolidone solvent, thereby preparing a positive active material slurry. The positive active material slurry was coated on an Al film and then dried and compressed, thereby manufacturing a positive electrode.

### Manufacture of Coin Cell

The positive electrode, a lithium metal as a counter electrode, a PTFE separator, and a solution in which 1.15 M LiPF₆ was prepared in a mixed solvent of EC (ethylene carbonate), DEC (diethyl carbonate), and EMC (ethylmethyl carbonate) (in a volume ratio of 3:4:3) as an electrolyte to manufacture a coin cell.

### Comparative Example 1

A positive active material was prepared according to substantially the same method as the Examples, except that the manganese hydroxide aqueous solution was not added, and then, a positive electrode and a coin cell were manufactured by utilizing the same.

### Comparative Example 2

A positive active material was prepared according to substantially the same method as Example 1, except that the nickel-based composite metal hydroxide (Ni_{0.94}Co_{0.04}Al_{0.02}(OH)₂) and the manganese hydroxide were dry-mixed, and then, a positive electrode and a coin cell were manufactured by utilizing the same.

### Comparative Example 3

A positive active material was prepared according to substantially the same method as Example 1, except that 1 mol % of Mn was coated, but the coating was performed through stirring for 1 hour and 30 minutes in a reactor, a resultant therefrom was dried and then, mixed with lithium hydroxide in a mole ratio of 1:1, the mixture was fired at 720° C. for 24 hours to dope Mn down to a core, and then, a positive electrode and a coin cell were manufactured by utilizing the same.

### Comparative Example 4

A positive active material was prepared according to substantially the same method as Example 1, except that 1.5 mol % of Mn was coated, and then, a positive electrode and a coin cell were manufactured by utilizing the same.

### Evaluation 1. Evaluation of Initial Charge/Discharge Capacity and Charge/Discharge Efficiency

The coin cells according to Examples 1 and 2 and Comparative Examples 1 to 4 were once charged and discharged at 0.2 C and then, analyzed with respect to charge capacity, discharge capacity, and charge and discharge efficiency. The results are shown in Table 1.

TABLE 1

| | | | Charge and |
|---|---|---|---|
| | Charge | Discharge | discharge |
| | capacity | capacity | efficiency |
| | (mAh/g) | (mAh/g) | (%) |
| Example 1 | 245.5 | 223.9 | 91.2% |
| Example 2 | 244.8 | 223.0 | 91.1% |
| Comparative Example 1 | 244.7 | 220.7 | 90.2% |
| Comparative Example 2 | 240.6 | 219.0 | 91.0% |
| Comparative Example 3 | 244.1 | 218.3 | 89.4% |
| Comparative Example 4 | 243.5 | 219.3 | 90.1% |

As shown in Table 1, the coin cell of Example 1 exhibited excellent or suitable charge and discharge capacity, as well as excellent or suitable charge and discharge efficiency, compared with the coin cells of Comparative Examples 1 to 4.

### Evaluation 2. Evaluation of Cycle Life Characteristics

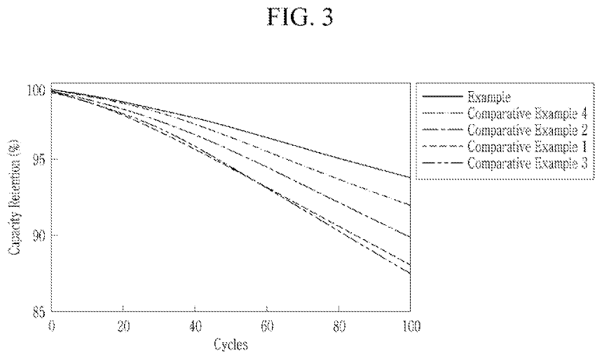

The coin cells according to Example 1 and Comparative Examples 1 to 4 were constant current-charged at a current rate of 1.0 C to a voltage of 4.30 V (vs. Li) and subsequently constant voltage-charged at 4.30 V with a cut off current of 0.05 C, at 45° C. Subsequently, the coin cells were constant current-discharged down to a voltage of 3.0 V (vs. Li) at a current rate of 1.0 C, which was regarded as one cycle and repeated up to 50^{th} cycles. In all the charge and discharge cycles, a pause of 10 minutes was set after every charge/discharge cycle. The coin cells were measured with respect to a cycle-life (capacity retention) at the 100^{th} cycle, and the results are shown in Table 2 and FIG. 3.

The capacity retention was calculated according to Equation 1:

Capacity retention rate at 100^{th} cycle [%]=[Discharge capacity at 100^{th} cycle/Discharge capacity at 1^{st} cycle]×100[%] Equation 1

TABLE 2

| | | Comparative | Comparative | Comparative | Comparative |
|---|---|---|---|---|---|
| | Example 1 | Example 1 | Example 2 | Example 3 | Example 4 |
| Cycle-life | 94.0% | 88.2% | 90.0% | 87.6% | 92.1% |
| 100 cycles | | | | | |

As shown in Table 2 and FIG. 3, the coin cells according to the examples (Example 1) exhibited excellent or suitable cycle-life, compared with the coin cells according to Comparative Examples 1 to 4.

Terms such as “substantially,” “about,” and “˜” are used as terms of approximation and not as terms of degree, and are intended to account for the inherent deviations in measured or calculated values that would be recognized by those of ordinary skill in the art. They may be inclusive of the stated value and an acceptable range of deviation as determined by one of ordinary skill in the art, considering the limitations and error associated with measurement of that quantity. For example, “about” may refer to one or more standard deviations, or ±30%, 20%, 10%, 5% of the stated value.

Numerical ranges disclosed herein include and are intended to disclose all subsumed sub-ranges of the same numerical precision. For example, a range of “1.0 to 10.0” includes all subranges having a minimum value equal to or greater than 1.0 and a maximum value equal to or less than 10.0, such as, for example, 2.4 to 7.6. Applicant therefore reserves the right to amend this specification, including the claims, to expressly recite any sub-range subsumed within the ranges expressly recited herein.

While this disclosure has been described in connection with what is presently considered to be practical example embodiments, it is to be understood that the disclosure is not limited to the disclosed embodiments. In contrast, it is intended to cover one or more suitable modifications and equivalent arrangements included within the spirit and scope of the appended claims and equivalents thereof.

### DESCRIPTION OF SOME OF THE SYMBOLS

1: secondary particle

3: primary particle

5a: shell

5b: core

7: grain boundary

31: rechargeable lithium battery

32: negative electrode

33: positive electrode

34: separator

35: battery case

36: cap assembly

What is claimed is:

1. A positive active material, comprising:
a nickel-based composite metal oxide comprising secondary particles in which a plurality of primary particles are agglomerated,
wherein the nickel-based composite metal oxide comprises a core and a shell,
the primary particles of the shell are coated with a manganese-containing nickel-based composite metal oxide, and
the manganese-containing nickel-based composite metal oxide has a layered structure.

2. The positive active material of claim 1, wherein the core does not include manganese.

3. The positive active material of claim 1, wherein a manganese concentration in the manganese-containing nickel-based composite metal oxide increases along a gradient from the interior to the surface of the primary particle of the shell.

4. The positive active material of claim 1, wherein the manganese-containing nickel-based composite metal oxide coated on the shell is in an island form or in a fine nanoparticle form.

5. The positive active material of claim 1, wherein the content of manganese is less than about 1.5 mol % with respect to the manganese-containing nickel-based composite metal oxide.

6. The positive active material of claim 1, wherein a thickness of the shell is less than or equal to about 2 μm.

7. The positive active material of claim 1, wherein each secondary particle has a particle diameter of about 8 μm to about 18 μm.

8. The positive active material of claim 1, wherein the manganese-containing nickel-based composite metal oxide is represented by Chemical Formula 1:
LiNi_{1-x-y-z}CoₓMn_{y}M_{z}O₂, and Chemical Formula 1
wherein, in Chemical Formula 1,
0≤x≤0.5, 0.001≤y<0.015, 0≤z≤0.3, and M is at least one metal or metalloid element selected from Ni, Al, Cr, Fe, V, Mg, Ti, Zr, Nb, Mo, W, Cu, Zn, Ga, In, Sn, La, B, Ta, Pr, Si, Ba, and Ce.

9. The positive active material of claim 1, wherein LiMnO₂ is on the surface of the primary particle of the shell.

10. A method of preparing the positive active material of claim 1, the method comprising:
adding a water-soluble solvent to a nickel-based composite metal compound and a manganese hydroxide to prepare a mixture,
reacting the mixture at about 40° C. to about 100° C. for about 30 minutes to about 1 hour to coat the primary particles of the shell with manganese, and
mixing the coated resulting material with a lithium source and firing the same.

11. The method of claim 10, wherein the nickel-based composite metal compound is one selected from a nickel composite metal oxide and a nickel composite metal hydroxide.

12. The method of claim 10, wherein the water-soluble solvent comprises NaOH, KOH, or a mixture thereof.

13. The method of claim 10, further comprising:
drying the mixture at about 100° C. to about 200° C. after the reacting of the mixture.

14. The method of claim 10, wherein a firing temperature is about 600° C. to about 800° C. and a firing time is about 8 hours to about 30 hours or about 8 hours to about 24 hours.

15. A rechargeable lithium battery, comprising:
a positive electrode comprising the positive active material of claim 1;
a negative electrode comprising a negative active material; and
an electrolyte.
